(19) United States
(12) Patent Application Publication
(10) Pub. No.: US 2026/0016775 A1
(43) Pub. Date: Jan. 15, 2026

(54) FIXING DEVICE AND IMAGE FORMING APPARATUS

(71) Applicant: KYOCERA Document Solutions Inc., Osaka (JP)

(72) Inventor: Yuhiro SAKAI, Osaka (JP)

(73) Assignee: KYOCERA Document Solutions Inc., Osaka (JP)

(21) Appl. No.: 19/264,146

(22) Filed: Jul. 9, 2025

(30) Foreign Application Priority Data
Jul. 11, 2024 (JP) 2024-111900

(51) Int. Cl. G03G 15/20; G03G 15/00

(52) U.S. Cl. CPC G03G 15/2017; G03G 15/2064; G03G 15/80; G03G 2215/2035

(57) ABSTRACT

A fixing device includes a fixing member, a pressure member, a fixing frame, a rolling bearing member, and a ground member. The fixing member heats a toner on a medium. The pressure member forms a pressure region with the fixing member and pressurizes the toner on the medium passing through the pressure region. The fixing frame supports both ends of the fixing member and the pressure member. The rolling bearing member is disposed between either of the fixing member and the pressure member and the fixing frame in an electrically insulated state. The ground member electrically grounds either of the fixing member and the pressure member via the rolling bearing member.

### INCORPORATION BY REFERENCE

This application is based on and claims the benefit of priority from Japanese patent application No. 2024-111900 filed on Jul. 11, 2024, which is incorporated by reference in its entirety.

The present disclosure relates to a fixing device which fixes a toner image on a medium and an image forming apparatus.

### BACKGROUND

A fixing device including a heating roller for heating a toner image transferred onto a sheet and a plate spring member (ground member) for electrically grounding the heating roller is known. In this fixing device, a plurality of conductive ring-shaped members having cutouts formed in a part of an arc are arranged in the axial direction such that the positions of the cutouts are not in the same phase, and are attached to the heating roller. Since the plate spring member abuts on the outer peripheral surfaces of the plurality of ring-shaped members, the surface of the heating roller is not damaged by the plate spring member.

### SUMMARY

A fixing device according to the present disclosure includes a fixing member, a pressure member, a fixing frame, a rolling bearing member, and a ground member. The fixing member heats a toner on a medium while rotating around an axis. The pressure member forms a pressure region with the fixing member and pressurizes the toner on the medium passing through the pressure region while rotating around an axis. The fixing frame supports both ends of the fixing member and the pressure member in the axial direction. The rolling bearing member is disposed between either of the fixing member and the pressure member and the fixing frame in an electrically insulated state. The ground member electrically grounds either of the fixing member and the pressure member via the rolling bearing member.

An image forming according to the present disclosure includes the fixing device.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a schematic view (side view) showing an internal structure of an image forming apparatus according to one embodiment of the present disclosure.

FIG. 2 is a perspective view showing a fixing device according to the embodiment of the present disclosure.

FIG. 3 is a perspective view showing a fixing belt and a pressure roller of the fixing device according to the embodiment of the present disclosure.

FIG. 4 is a cross-sectional view taken along the line IV-IV in FIG. 3.

FIG. 5 is a perspective view showing a grounding structure of the fixing device according to the embodiment of the present disclosure.

FIG. 6 is a disassembled perspective view showing the grounding structure of the fixing device according to the embodiment of the present disclosure.

FIG. 7 is a side view showing the grounding structure of the fixing device according to an embodiment of the present disclosure.

FIG. 8 is a cross-sectional view taken along the line VIII-VIII in FIG. 7.

### DETAILED DESCRIPTION

Hereinafter, with reference to the attached drawings, an embodiment of the present disclosure will be described. Fr, Rr, L, R, U and D shown in the drawings indicate the front, rear, left, right, upper and down. The front-and-rear direction, the left-and-right (axial direction), and the upper-and-lower direction are orthogonal to each other. Although the terms showing orientation and position are used herein, these terms are used for convenience of explanation and are not intended to limit the scope of the disclosure. The terms “upstream”, “downstream”, and the like refer to the concepts “upstream”, “downstream”, and the like in the conveyance direction of the paper P (medium). In each of the figures, the dimensions and angles of the members are not accurate and are schematized for the sake of explanation.

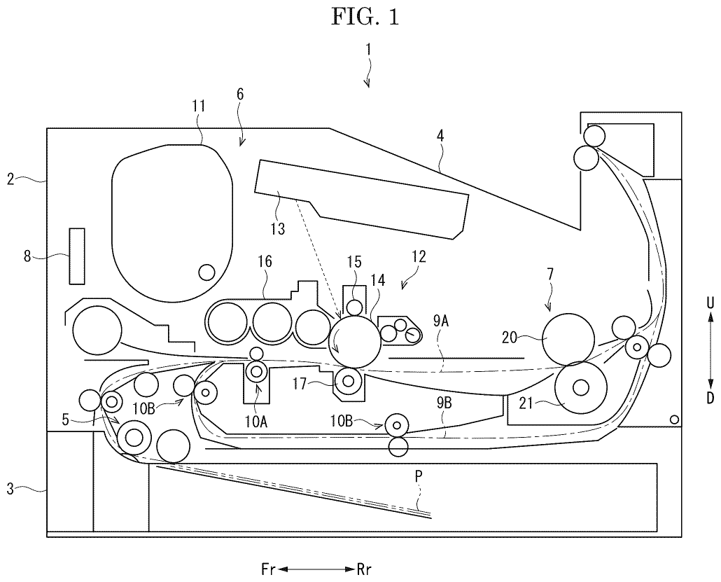

With reference to FIG. 1, an image forming apparatus 1 according to one embodiment will be described. FIG. 1 is a schematic view (side view) showing the image forming apparatus 1.

The image forming apparatus 1 is an electrophotographic printer. The image forming apparatus 1 includes an apparatus main body 2 constituting a substantially rectangular parallelepiped appearance. A paper feeding cassette 3 which stores a paper P (medium), for example, is detachably provided in the lower portion of the apparatus main body 2. A paper discharge tray 4 is provided on the upper surface of the apparatus main body 2. The paper P as an example of the medium is not limited to a paper sheet but may be a resin sheet or the like.

The image forming apparatus 1 includes a paper feeding device 5, an image forming device 6, and a fixing device 7. The paper feeding device 5 is provided at the upstream end portion of a conveyance path 9A extending from the paper feeding cassette 3 to the paper discharge tray 4, and feeds the papers P stored in the paper feeding cassette 3 to the conveyance path 9A one by one. The image forming device 6 is provided in an intermediate portion of the conveyance path 9A, and forms a toner image on the conveyed paper P. The fixing device 7 is provided on the downstream portion of the conveyance path 9A, and thermally fixes the toner image to the paper P.

On the conveyance path 9A, a pair of registration rollers 10 for temporarily blocking the conveyed paper P and correcting the skew of the paper P (skew correction) is provided. An inversion conveyance path 9B is provided below the conveyance path 9A, which branches from the downstream portion of the conveyance path 9A and joins the upstream portion of the conveyance path 9A. On the inversion conveyance path 9B, a plurality of pairs of conveying rollers 10B for conveying the paper P are provided.

The image forming device 6 includes a toner container 11, a drum unit 12, and an optical scanner 13. The toner container 11 is disposed in the front upper portion of the apparatus main body 2, and contains, for example, black toner (developer). The drum unit 12 includes a photosensitive drum 14, a charging device 15, a developing device 16, and a transfer roller 17. The photosensitive drum 14 is formed in a substantially cylindrical shape, and is driven to be rotated around an axis by a motor (not shown). The charging device 15, the developing device 16 and the transfer roller 17 are arranged around the photosensitive drum 14 in the order of the image forming process. The transfer roller 17 is in contact with the photosensitive drum 14 from the lower side to form a transfer nip. The optical scanner 13 is provided above the photosensitive drum 14, and emits scanning light toward the surface of the photosensitive drum 14.

The image forming apparatus 1 is provided with a control part 8 for controlling the entire apparatus. The control part 8 includes a processor or the like which executes various processes by reading and executing a program stored in a memory. The control part 8 is not limited to the processor or the like, but may be formed of a logic circuit (hardware) formed in an integrated circuit or the like.

[Image Forming Process] An operation of the image forming apparatus 1 will be described. The control part 8 for controlling the image forming apparatus 1 performs image forming processing based on image data input from an external terminal as follows.

The charging device 15 charges the surface of the photosensitive drum 14, and the optical scanner 13 emits scanning light based on image data to form an electrostatic latent image on the photosensitive drum 14. The developing device 16 develops the electrostatic latent image into a toner image on the photosensitive drum 14 by using the toner supplied from the toner container 11. The paper feeding device 5 feeds the paper P one by one from the paper feeding cassette 3 to the conveyance path 9A. The paper P is conveyed along the conveyance path 9A, the skew is corrected by the pair of registration rollers 10A, and enters the transfer nip. The transfer roller 17 transfers the toner image on the photosensitive drum 14 to the surface of the paper P passing through the transfer nip. The fixing device 7 thermally fixes the toner image to the paper P. In the case of single-sided printing, the paper P which has passed through the fixing device 7 is discharged to the paper discharge tray 4.

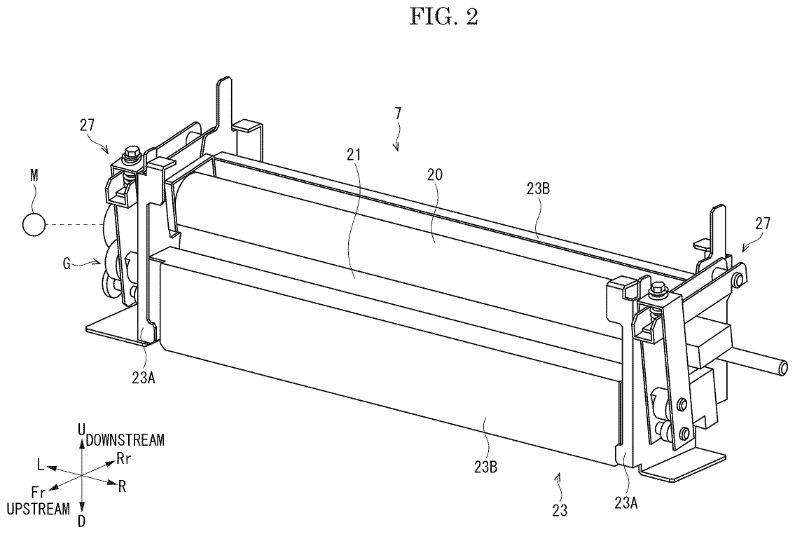

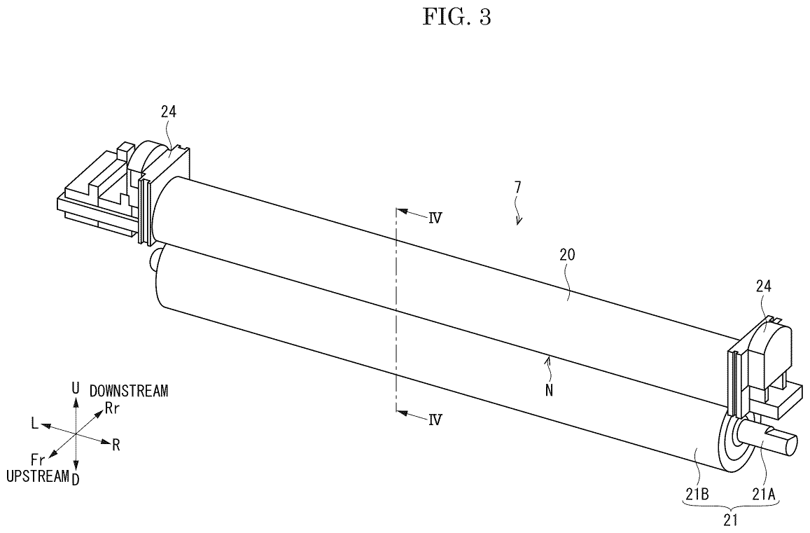

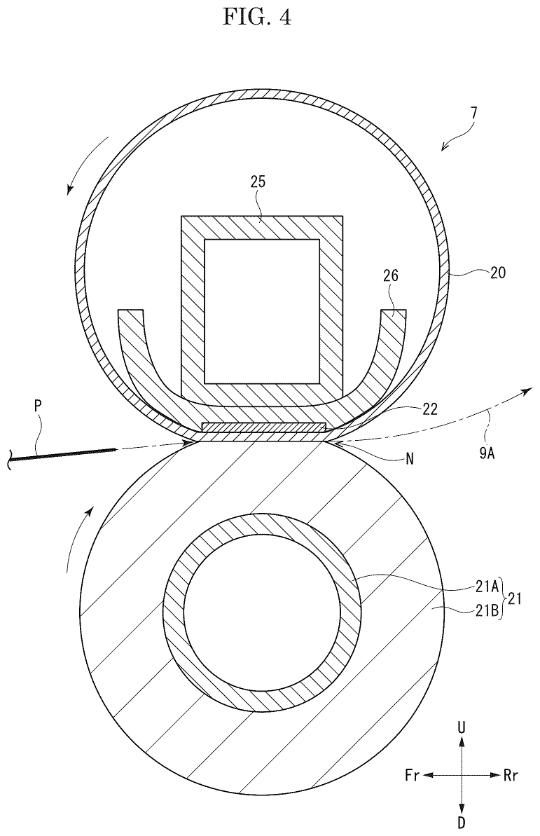

In the case of double-sided printing, the paper P that has passed through the fixing device 7 is switched back at the downstream end of the conveyance path 9A and sent to the inversion conveyance path 9B. The paper P is conveyed by the pair of conveying rollers 10B, returned from the inversion conveyance path 9B to the conveyance path 9A again, and sent to the transfer nip after the skew correction by the pair of registration rollers 10A. Thereafter, the toner image is transferred to the paper P, thermally fixed, and the double-sided printed paper P is discharged to the paper discharge tray 4.

[Fixing Device] Next, the fixing device 7 will be described with reference to FIG. 2 to FIG. 4. FIG. 2 is a perspective view showing the fixing device 7. FIG. 3 is a perspective view showing a fixing belt 20 and a pressure roller 21. FIG. 4 is a cross-sectional view taken along the line IV-IV in FIG. 3.

The fixing device 7 includes the fixing belt 20, the pressure roller 21, a heater 22, and a fixing frame 23.

<Fixing Belt> As shown in FIG. 2 to FIG. 4, the fixing belt 20 as an example of the fixing member is an endless belt formed in a substantially cylindrical shape elongated in the left-and-right direction (axial direction). The fixing belt 20 is made of material having heat resistance and flexibility (polymer resin or metal, or combination of polymer resin and metal). A pair of holding members 24 (see FIG. 3) are inserted into both ends of the fixing belt 20 in the left-and-right direction (axial direction). The pair of holding members 24 guide the fixing belt 20 rotatably around an axis while holding the fixing belt in a substantially cylindrical shape.

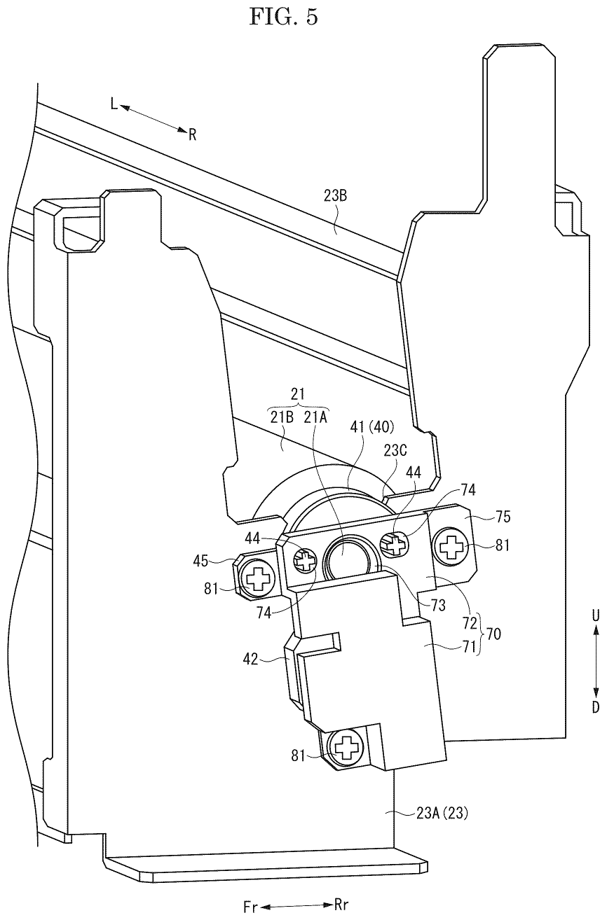

As shown in FIG. 4, a support member 25 and a heater holder 26 are provided in a space surrounded by the fixing belt 20. The support member 25 is made of, for example, metal (conductor) such as stainless steel, and is formed in a substantially rectangular cylindrical shape elongated in the left-and-right direction (axial direction), and is provided between the pair of holding members 24. The heater holder 26 is mounted on the lower portion of the support member 25. The heater holder 26 is made of, for example, synthetic resin having heat resistance and wear resistance, and is formed in a substantially semi-cylindrical shape elongated in the left-and-right direction. The heater holder 26 is curved along the inner surface of the fixing belt 20, and is in contact with the lower side portion (on the side of the pressure region N) of the inner surface of the fixing belt 20. A heater 22 is fitted in the lower portion of the heater holder 26.

<Pressure Roller> As shown in FIG. 3 and FIG. 4, the pressure roller 21 as an example of the pressure member is formed in a substantially cylindrical shape elongated in the left-and-right direction. The pressure roller 21 has a core 21A made of metal (conductor) such as stainless steel or aluminum alloy, and an elastic layer 21B made of an elastic material such as silicon sponge and laminated on the outer peripheral surface of the core 21A (see FIG. 4). A drive motor M is connected to the left end of the core 21A as an example of the rotational shaft portion via a gear train G (see FIG. 2). The pressure roller 21 is pressed against the fixing belt 20 by pressing mechanisms 27 (see FIG. 2) provided on both sides in the left-and-right direction. The pressure roller 21 comes into contact with the fixing belt 20 from below, and forms the pressure region N between the fixing belt 20 and the pressure roller 21. When the paper P passes through the pressure region N, the toner image is fixed on the paper P. The pressure region N refers to a region from an upstream position where the pressure is 0 Pa to a downstream position where the pressure becomes 0 Pa again via a position where the pressure acts.

<Heater> The heater 22 has a substrate made of insulator such as ceramic and a plurality of heating resistors made of metal material having a high electrical resistance value and formed on the lower surface of the substrate. The plurality of heating resistors are electrically connected to a power source or the like (not shown) via an electrode portion formed on the substrate. The heater 22 (substrate) extends in the left-and-right direction (axial direction) of the fixing belt 20, and is fitted in the lower portion of the heater holder 26 with the heating resistors facing downward (see FIG. 4). When the heater 22 receives the fixing belt 20 pressed against the pressure roller 21, the pressure region N is formed at a contact portion between the fixing belt 20 and the pressure roller 21. The heater 22 (heating resistor) comes into contact with the inner surface of the fixing belt 20 facing the pressure region N, and heats the fixing belt 20. In order to reduce friction between the heater 22 and the fixing belt 20, the heating resistors are covered with a coating layer (not shown). The fixing device 7 is provided with a temperature detection part (not shown) for detecting a temperature of the heater 22.

<Fixing Frame> The fixing frame 23 forms the skeleton of the fixing device 7, and is mounted on the apparatus main body 2. The fixing frame 23 is made of metal (conductor) such as stainless steel or aluminum alloy, for example. As shown in FIG. 2, the fixing frame 23 includes a pair of standing plates 23A arranged in a standing posture spaced apart in the left-and-right direction, and a plurality of connection bars 23B provided between the pair of standing plates 23A. A notch 23C (see FIG. 5, which will be described later) is formed in each of the standing plates 23A from above to below, and both end portions of the fixing belt 20 and the pressure roller 21 in the left-and-right direction (axial direction) are supported in the notches 23C of the pair of standing plates 23A. More specifically, the holding member 24, a rolling bearing member 30 and the like (to be described later) are attached to each notch 23C. The fixing belt 20 is rotatably supported on the fixing frame 23 via the pair of holding members 24, and the pressure roller 21 is rotatably supported on the fixing frame 23 via the pair of rolling bearing members 30 and the like.

[Action of Fixing Device] Here, an operation (fixing process) of the fixing device 7 will be described. The drive motor M, the heater 22, the temperature detection part and the like are electrically connected to the control part 8, the power source and the like, and the control part 8 appropriately controls the power source, the heater 22 and the like.

The control part 8 controls the drive motor M to rotate the pressure roller 21 around the axis. The fixing belt 20 rotates in accordance with the pressure roller 21 (see the arrow in FIG. 4). The control part 8 receives a detection signal from the temperature detection part and controls the heater 22 (or the power supply) so as to maintain a preset target temperature. The heater 22 generates heat by being powered and heats the fixing belt 20 (pressure region N).

When a temperature of the fixing belt 20 (heater 22) reaches the target temperature, the control part 8 starts the image forming process already described. The paper P on which the toner image is transferred enters the pressure region N. The fixing belt 20 heats the toner (toner image) on the paper P passing through the pressure region N while rotating around the axis. The pressure roller 21 pressurizes the toner on the paper P passing through the pressure region N while rotating around the axis. Then, the toner image is fixed to the paper P, and a fixed image is formed on the paper P. The paper P on which the image is fixed is discharged to the paper discharge tray 4.

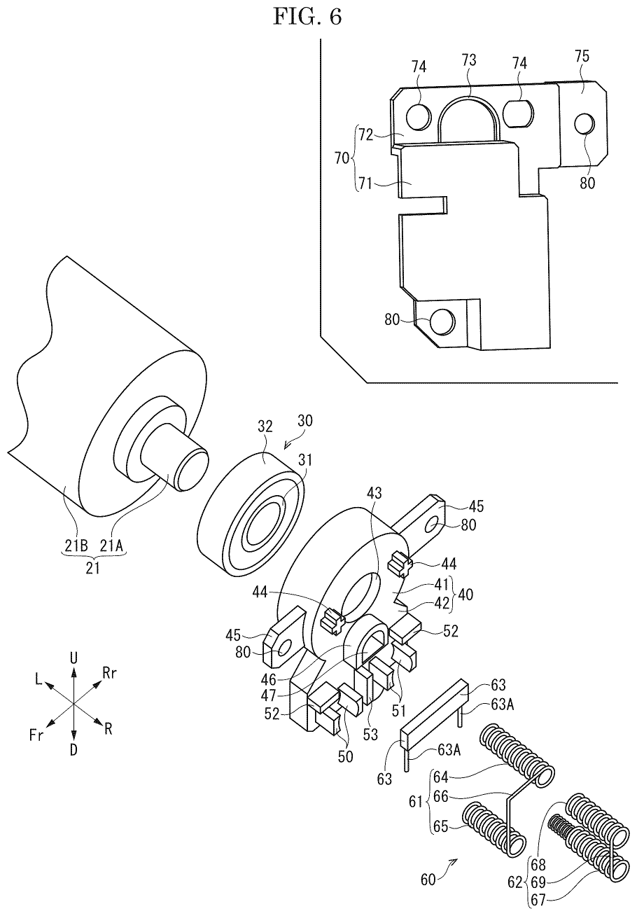

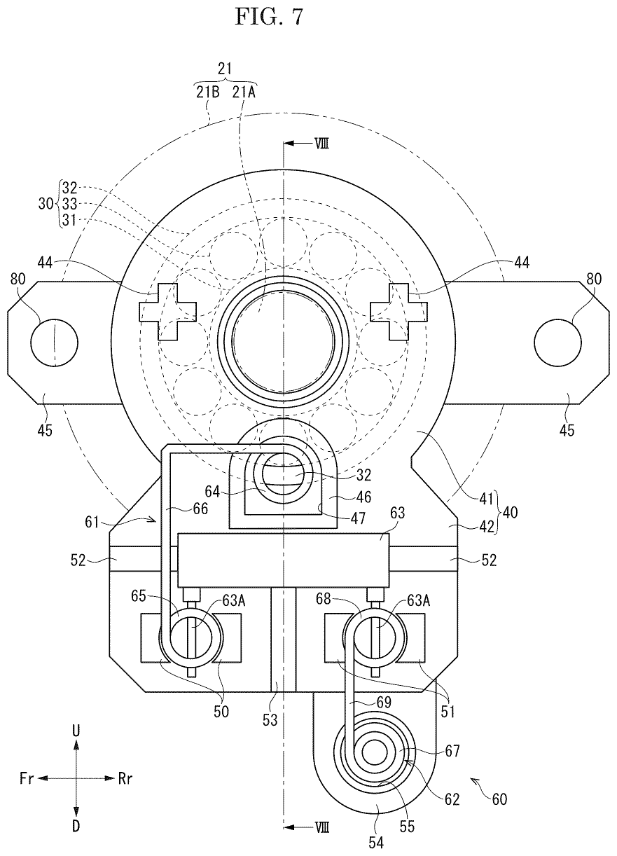

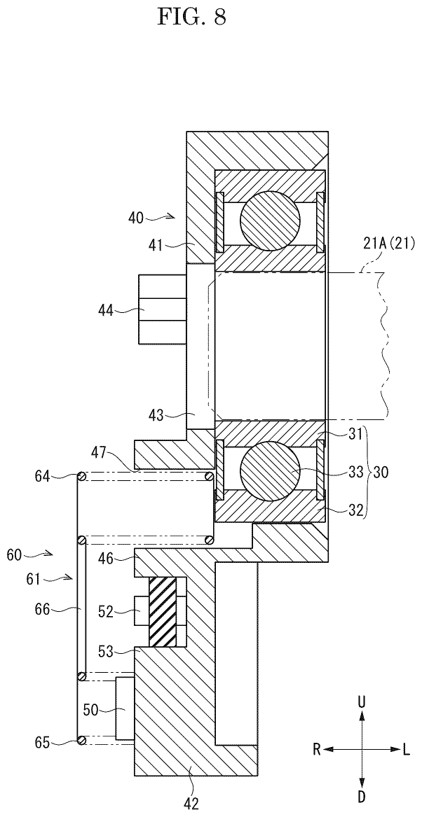

Incidentally, the fixing device 7 is provided with a ground member 60 for electrically grounding (FG: frame ground) the pressure roller 21 (core 21A) in order to remove static electricity from the pressure roller 21 and to suppress malfunction of the control part 8 and other equipment (electric circuit) caused by noise. If the ground member 60 is brought into direct contact with the core 21A of the pressure roller 21, since the pressure roller 21 rotates around the axis, both the core 21A and the ground member 60 rub against each other, causing abrasion or an abnormal sound (frictional sound) As the abrasion of both of them progresses, the pressure roller 21 may not be properly grounded, and it may not be able to remove static electricity or suppress malfunction. Therefore, the fixing device 7 according to the present embodiment is provided with a grounding structure for suppressing abrasion of the ground member 60 and the like and generation of abnormal noise at the contact portion of the ground member 60.

[Grounding Structure] The grounding structure of the fixing device 7 according to the present embodiment will be described with reference to FIG. 5 to FIG. 8. FIG. 5 is a perspective view showing the grounding structure of the fixing device 7. FIG. 6 is a disassembled perspective view showing the grounding structure of the fixing device 7. FIG. 7 is a side view showing the grounding structure of the fixing device 7. FIG. 8 is a cross-sectional view taken along the line VIII-VIII of FIG. 7.

As shown in FIG. 5 and FIG. 6, the grounding structure includes the rolling bearing member 30, a bearing holder 40, the ground member 60, and a ground cover 70. The rolling bearing member 30 and the bearing holder 40 are provided as one pair to support both right and left ends of the core 21A of the pressure roller 21, and the ground member 60 and the ground cover 70 are provided only on the right side of the pressure roller 21 (core 21A). For convenience of explanation, the description will be made by focusing on the right side of the pressure roller 21 (core 21A) provided with the ground member 60 and the like.

<Rolling Bearing Member> The rolling bearing member 30 is, for example, a so-called ball bearing made of high-carbon chromium bearing steel. As shown in FIG. 7 and FIG. 8, the rolling bearing member 30 has an inner ring 31, an outer ring 32, and a plurality of rolling elements 33 (balls). The inner ring 31 is formed in an annular shape into which the core 21A of the pressure roller 21 can be inserted, and supports the core 21A rotatably around the axis. The outer ring 32 is formed in an annular shape having a larger diameter than the inner ring 31, and is provided coaxially with the inner ring 31. The plurality of rolling elements 33 are held between the outer peripheral surface of the inner ring 31 and the outer ring 32. Each of the plurality of rolling elements 33 is a sphere, and is provided between the inner ring 31 and the outer ring 32 while being held by a retainer (not shown).

<Bearing Holder> The bearing holder 40 is made (integrally molded) of insulator such as synthetic resin. As shown in FIG. 6, the bearing holder 40 includes a bearing fitting portion 41 and a ground support portion 42.

(Bearing Fitting Portion) The bearing fitting portion 41 is formed in a generally cylindrical shape with its left surface (inner surface in the axial direction) open, and the rolling bearing member 30 (outer ring 32) is fitted into the bearing fitting portion 41 substantially loosely. A shaft opening 43 for exposing the end of the core 21A passing through the inner ring 31 of the rolling bearing member 30 is opened in the right surface (outer surface in the axial direction) of the bearing fitting portion 41. A pair of positioning bosses 44 protrude from the right surface of the bearing fitting portion 41 on both sides of the shaft opening 43. A pair of mounting arms 45 are integrally formed in the bearing fitting portion 41. The pair of mounting arms 45 extend outward from both sides of the bearing fitting portion 41 in the front-and-rear direction. The mounting arm 45 has a through-hole 80 for penetrating a mounting screw 81.

(Grounding Support Portion) The ground support portion 42 is provided below the bearing fitting portion 41, and formed integrally with the bearing fitting portion 41. Near the boundary between the ground support portion 42 and the bearing fitting portion 41, a guide cylindrical portion 46 protrudes rightward (outside in the axial direction). The guide cylindrical portion 46 is formed in a cylindrical shape having a dome-shaped cross section of a rectangle with a semicircular upper part. A guide hole 47 penetrates the guide cylindrical portion 46 so as to face the right end (outer edge in the axial direction) of the outer ring 32 of the rolling bearing member 30 fitted in the bearing fitting portion 41 (see also FIG. 8).

A first pair of support pieces 50 and a second pair of support pieces 51 are arranged in the front-and-rear direction in the lower portion of the ground support portion 42, and protrude rightward (outside in the axial direction). The first and second support piece pairs 50 and 51 are disposed opposite to each other in the front-and-rear direction with a gap. A pair of horizontal ribs 52 protrude rightward (outside in the axial direction) from both side portions of the ground support portion 42 in the front-and-rear direction and between the guide cylindrical portion 46 and the first and second support piece pairs 50 and 51. Further, on the lower portion of the ground support portion 42, a vertical rib 53 protrudes rightward (outside in the axial direction) so as to partition the first pair of support pieces 50 and the second pair of support pieces 51. The ground support portion 42 is integrally formed with a ground piece 54 having a ground hole 55 (see FIG. 7). The ground piece 54 extends downward from the lower surface of the ground support portion 42 (see FIG. 7).

<Ground Member> As shown in FIG. 6, the ground member 60 includes a first conductive member 61, a second conductive member 62, and a resistance member 63. Each of the first conductive member 61 and the second conductive member 62 includes a portion formed so as to be extendable and compressible in the left-and-right direction (axial direction). Specifically, each of the first conductive member 61 and the second conductive member 62 includes, for example, a compression coil spring made of a metal wire (conductor) such as stainless steel.

(First Conductive Member) The first conductive member 61 has a first contact spring 64, a first support spring 65, and a first connection portion 66, and is integrally formed. The first contact spring 64 and the first support spring 65 are compression coil springs extending substantially parallel to each other in the left-and-right direction (axial direction). The first support spring 65 is disposed in front of and below the first contact spring 64 (see also FIG. 7). The first connection portion 66 is bent in a substantially L-shape when viewed from the axial direction, and connects the right end (outer end in the axial direction) of the first contact spring 64 and the right end of the first support spring 65 (see also FIG. 7).

(Second Conductive Member) The second conductive member 62 has a second contact spring 67, a second support spring 68, and a second connection portion 69, and is integrally formed. The second contact spring 67 and the second support spring 68 are compression coil springs extending substantially parallel to each other in the left-and-right direction (axial direction). The second support spring 68 is disposed above the second contact spring 67. The second connection portion 69 is formed in a straight line, and connects the right end (outer end in the axial direction) of the second contact spring 67 to the right end of the second support spring 68 (see also FIG. 7). The distal end (left end) of the second contact spring 67 is formed to have a smaller diameter than the right end.

(Resistance Member) The resistance member 63 is a resistor for limiting the current flowing in the circuit, and is formed in a substantially plate-like shape elongated in the front-and-rear direction. The resistance member 63 is provided with a pair of resistance connection lines 63A. The pair of resistance connection lines 63A extend downward from both front and rear end portions of the lower surface of the resistance member 63.

<Ground Cover> The ground cover 70 is made (integrally molded) of insulator such as synthetic resin. As shown in FIGS. 5 and 6, the ground cover 70 includes a pressing cover portion 71 and a mounting cover portion 72.

(Pressing Cover Portion) The pressing cover portion 71 is formed in a box shape such that the left side thereof is opened to cover the ground support portion 42 (including the guide cylindrical portion 46) of the bearing holder 40. Four spring bosses (not shown) protrude from the inner surface of the pressing cover portion 71 at positions corresponding to the guide cylindrical portion 46, the first pair of support pieces 50, the second pair of support pieces 51, and the ground hole 55. A through-hole 80 for penetrating a mounting screw 81 is opened in the front lower corner of the mounting cover portion 72.

(Mounting Cover Portion) The mounting cover portion 72 is formed in a substantially flat plate shape extending upward from the upper portion and left end portion of the pressing cover portion 71. The mounting cover portion 72 has a cover opening 73 so as to corresponding to the shaft opening 43 of the bearing fitting portion 41. The mounting cover portion 72 has a pair of front and rear positioning holes 74 on both sides of the cover opening 73. The front positioning hole 74 is a round hole having a substantially perfect circle, and the rear positioning hole 74 is an elongated hole elongated in the front-and-rear direction. A cover arm 75 extending rearward is integrally formed with the mounting cover portion 72. The cover arm 75 has a through-hole 80 for penetrating a mounting screw 81.

[Grounding Structure Formation] The bearing holder 40 is mounted on the fixing frame 23 while holding the rolling bearing member 30. Specifically, the rolling bearing member 30 is fitted into the bearing fitting portion 41 of the bearing holder 40, and the end of the core 21A of the pressure roller 21 is fitted into the inner ring 31 of the rolling bearing member 30 (see FIG. 7 and FIG. 8). The bearing holder 40 (bearing fitting portion 41) holding the rolling bearing member 30 is inserted into the notch 23C of the standing plate 23A of the fixing frame 23 from above (see FIG. 5).

Subsequently, the ground member 60 is attached to the bearing holder 40. Specifically, the resistance member 63 is fitted and mounted on the area surrounded by the guide cylindrical portion, the pair of horizontal ribs 52 and vertical ribs 53 of the ground support portion 42 (see FIG. 7 and FIG. 8). The pair of resistance connection lines 63A are disposed between the pair of first support pieces 50 and between the pair of second support piece 51 (see FIG. 7). Next, the first contact spring 64 of the first conductive member 61 is inserted into the guide hole 47 of the ground support portion 42, and the first support spring 65 is inserted between the pair of first support pieces 50 of the ground support portion 42 (see FIG. 7 and FIG. 8). Thus, the first conductive member 61 is supported by the guide cylindrical portion 46 and the pair of first support pieces 50. Further, the second contact spring 67 of the second conductive member 62 is inserted into the ground hole 55 of the ground support portion 42 (ground piece 54), and the second support spring 68 is inserted between the pair of second support pieces 51 of the ground support portion 42 (see FIG. 7). Thus, the second conductive member 62 is supported by the ground piece 54 and the pair of second support pieces 51.

In this state, the first contact spring 64 is in contact with the outer ring 32 of the rolling bearing member 30 through the guide hole 47 (see FIG. 7 and FIG. 8). More specifically, the tip end of the first contact spring 64 passing through the guide hole 47 is in contact with (connected to) the right end (outer edge in the axial direction) of the outer ring 32 (see FIG. 8). The second contact spring 67 (its tip end) is into contact with (connected to) the standing plate 23A of the fixing frame 23 through the ground hole 55. On the other hand, the tip of the first support spring 65 and the tip of the second support spring 68 are in contact with the pair of resistance connection lines 63A of the resistance member 63 (see FIG. 7). In this manner, the resistance member 63 is provided between the first conductive member 61 and the second conductive member 62, and is connected to the first conductive member 61 and the second conductive member 62. The ground member 60 electrically grounds the pressure roller 21 via the rolling bearing member 30.

Next, the ground cover 70 is mounted on the bearing holder 40 so as to cover the ground member 60. Specifically, the ground cover 70 is disposed so as to hold the ground member 60 with the bearing holder 40. At this time, the pair of positioning bosses 44 formed in the bearing holder 40 are inserted into the pair of positioning holes 74 formed in the ground cover 70 (see FIG. 5), and the four spring bosses formed in the ground cover 70 are inserted into the first contact spring 64, the first support spring 65, the second contact spring 67 and the second support spring 68 supported by the bearing holder 40. In this state, the ground cover 70 is properly positioned relative to the bearing holder 40, the cover opening 73 substantially corresponds to the shaft opening 43, and the cover arm 75 overlaps the rear mounting arm 45 to substantially correspond the through-hole 80 with the through-hole 80.

Finally, the three mounting screws 81 penetrate through the through-holes 80 of the pair of mounting arms 45 (cover arms 75) and the through-hole 80 of the front lower corner of the ground cover 70, and are screwed into the female screw holes (not shown) formed in the standing plate 23A (see FIG. 5). The mounting screws 81 on the rear upper portion fasten the mounting arm 45 and the cover arm 75 together.

Thus, the grounding structure is formed (see FIG. 5). The bearing holder 40 is mounted on the fixing frame 23 while holding the rolling bearing member 30 and the ground member 60. The outer ring 32 of the rolling bearing member 30 is mounted on the fixing frame 23 in an electrically insulated state via the bearing holder 40. The ground cover 70 is mounted on the bearing holder 40 while compressing the first conductive member 61 and the second conductive member 62. The first contact spring 64 is pressed against the outer edge of the outer ring 32 of the rolling bearing member 30, and the second contact spring 67 is pressed against the standing plate 23A of the fixing frame 23. The first support spring 65 and the second support spring 68 are pressed against the pair of resistance connection lines 63A of the resistance member 63. Thus, the pressure roller 21 is grounded (frame ground) to the fixing frame 23 via the rolling bearing member 30 and the ground member 60.

In the fixing device 7 according to the present embodiment described above, the ground member 60 is in contact with the outer ring 32 of the rolling bearing member 30 and electrically grounds the pressure roller 21 via the rolling bearing member 30. According to this configuration, since the ground member 60 is in contact with the outer ring 32 of the rolling bearing member 30 held immovably by the fixing frame 23, it is possible to suppress the abrasion of the ground member 60 and the occurrence of abnormal noise at the contact portion of the ground member 60.

According to the fixing device 7 according to the present embodiment, since the bearing holder 40 made of insulator is mounted on the fixing frame 23 while holding the rolling bearing member 30, the rolling bearing member 30 can be held to the fixing frame 23 in an electrically insulated state. Since the ground cover 70 is mounted on the bearing holder 40 so as to cover the ground member 60 in contact with the outer ring 32 through the guide hole 47, the ground member 60 can be held in contact with the outer ring 32.

The pressure roller 21 receives heat from the fixing belt 20 heated by the heater 22, and extends in the axial direction, or cools and contracts in the axial direction while the image forming process (fixing process) is stopped. Accordingly, the rolling bearing member 30 may move slightly in the axial direction. According to the fixing device 7 according to the present embodiment, since the ground member 60 (first conductive member 61, second conductive member 62) includes the portion formed to be axially extended and compressed, fine axial displacement of the rolling bearing member 30 caused by the extension and contraction of the pressure roller 21 can be absorbed. Thus, the ground member 60 can be kept in contact with the outer edge of the outer ring 32 in the axial direction, and the pressure roller 21 can be kept properly grounded.

Incidentally, if the heater 22 runs out of control, there is a possibility that an overcurrent flows into the pressure roller 21 (core 21A). When this overcurrent reaches the fixing frame 23 through the rolling bearing member 30 and the ground member 60, the electric circuit or the like included in the image forming apparatus 1 may be damaged. In the fixing device 7 according to the present embodiment, the first conductive member 61 is connected to the pressure roller 21 via the rolling bearing member 30, and the second conductive member 62 is connected to the first conductive member 61 via the resistance member 63 and to the fixing frame 23. According to this configuration, the electrical resistance from the pressure roller 21 to the fixing frame 23 through the rolling bearing member 30 and the ground member 60 can be increased. As a result, the overcurrent is prevented from being transmitted to the fixing frame 23, and damage to the electric circuit or the like included in the image forming apparatus 1 can be prevented.

In the fixing device 7 according to the present embodiment, the ground member 60 grounds the pressure roller 21 via the rolling bearing member 30, but the present disclosure is not limited thereto. For example, if the fixing member is formed in the same roller shape as the pressure roller 21, the ground member 60 may ground the fixing member via the rolling bearing member 30 (not shown). The grounding structure (such as the ground member 60) is provided on the right side of the fixing device 7, but may be provided on the left side of the fixing device 7 (not shown).

In the fixing device 7 according to the present embodiment, the rolling bearing member 30 is a ball bearing including the spherical rolling elements 33, but the present disclosure is not limited thereto. For example, the rolling bearing member 30 may be a roller bearing including a cylindrical, needle or conical rolling element 33.

In the fixing device 7 according to the present embodiment, the bearing holder 40 is mounted on the fixing frame 23 while holding the rolling bearing member 30 and the ground member 60, but the present disclosure is not limited thereto. For example, a holder for holding the rolling bearing member 30 and a holder for holding the ground member 60 may be provided separately (not shown).

In the fixing device 7 according to the present embodiment, both of the first and second conductive members 61 and 62 of the ground member 60 include the compression coil spring as the axially extendable and compressible portion, but the present disclosure is not limited thereto. For example, at least one of the first conductive member 61 and the second conductive member 62 may be made of a plate spring or the like (not shown). Further, for example, the first conductive member 61 or the second conductive member 62 may be axially extensible and compressible (not shown). Further, both of the first and second conductive members 61, 62 may be formed to be inextensible and incompressible in the axial direction, such as, for example, rod-shaped terminals (not shown).

In the fixing device 7 according to the present embodiment, the ground member 60 (the first conductive member 61) is in contact with the outer edge of the outer ring 32 of the rolling bearing member 30 in the axial direction, but it is not limited to this, and may be in contact with, for example, the outer peripheral surface of the outer ring 32 (not shown). Further, although the ground member 60 (the second conductive member 62) is in contact with the standing plate 23A, it is not limited thereto and may be in contact with, for example, the connection bar 23B (not shown).

In the fixing device 7 according to the present embodiment, the ground member 60 has the resistance member 63, but the present disclosure is not limited thereto. For example, if there is sufficient electrical insulation between the heater 22 and the pressure roller 21 (core 21A), the resistance member 63 may be omitted (not shown). When the resistance member 63 is omitted, for example, the second conductive member 62 may be omitted, and the first conductive member 61 may be in contact with the outer ring 32 of the rolling bearing member 30 and the fixing frame 23 (not shown).

In the fixing device 7 according to the present embodiment, although the pressure roller 21 is rotationally driven and the fixing belt 20 is driven to be rotated, the fixing belt 20 may be rotationally driven and the pressure roller 21 may be driven to be rotated.

In the description of the above embodiment, the present disclosure is applied to the monochrome image forming apparatus 1 as an example, but the present disclosure is not limited to this, and may be applied to, for example, a color printer, a copying machine, a facsimile machine and a multifunctional peripheral.

It should be noted that the description of the above embodiments shows one aspect of the fixing device and the image forming apparatus according to the present disclosure, and the technical range of the present disclosure is not limited to the above embodiments. The disclosure may be variously modified, substituted or modified without departing from the spirit of the technical thought, and the claims include all embodiments which may be included within the scope of the technical thought.

1. A fixing device comprising:
a fixing member which heats a toner on a medium while rotating around an axis;
a pressure member which forms a pressure region with the fixing member and pressurizes the toner on the medium passing through the pressure region while rotating around an axis;
a fixing frame which supports both ends of the fixing member and the pressure member in the axial direction;
a rolling bearing member which is disposed between either of the fixing member and the pressure member and the fixing frame in an electrically insulated state; and
a ground member which electrically grounds either of the fixing member and the pressure member via the rolling bearing member.

2. The fixing device according to claim 1, wherein
the rolling bearing member includes an inner ring which rotatably supports a rotational shaft portion of either of the fixing member and the pressure member around the axis, an outer ring which is mounted on the fixing frame in an electrically insulated state, and a rolling element held between the inner ring and the outer ring; and
the ground member is in contact with the outer ring.

3. The fixing device according to claim 2, further comprising:
a bearing holder which is made of insulator, mounted on the fixing frame while holding the rolling bearing member and the ground member, and have a guide hole into which the ground member is inserted to bring it into contact with the outer ring; and
a ground cover which is made of insulator, and mounted on the bearing holder so as to cover the ground member in contact with the outer ring through the guide hole.

4. The fixing device according to claim 2, wherein
the ground member has a portion formed to be extensible and compressible in the axial direction and is in contact with an outer edge of the outer ring in the axial direction.

5. The fixing device according to claim 2, wherein
the ground member includes:
a first conductive member in contact with the outer ring;
a second conductive member in contact with the fixing frame; and
a resistance member which is provided between the first conductive member and the second conductive member and connected to the first conductive member and the second conductive member.

6. The fixing device according to claim 5, wherein
the first conductive member and the second conductive member have a portion formed to be extensible and compressible in the axial direction, and
the first conductive member is in contact with an outer edge of the outer ring in the axial direction.

7. An image forming apparatus comprising the fixing device according to claim 1.
